(19) United States
(12) Patent Application Publication
(10) Pub. No.: US 2023/0206457 A1
(43) Pub. Date: Jun. 29, 2023

(54) System and method for counting corrugations in a flexible material

(71) Applicant: Coulisse B.V., Enter (NL)

(72) Inventors: Ruben Hubert Jan De Vries, Zevenaar (NL); Bastiaan Franciscus Klein Tuente, Groenlo (NL); Sasa Jusufovic, Landgraaf (NL); Maarten Petrus Maria Janssens, Epen (NL)

(21) Appl. No.: 18/064,304

(22) Filed: Dec. 12, 2022

(30) Foreign Application Priority Data
Dec. 23, 2021 (NL) 2030264

(51) Int. Cl. G06T 7/13; G01B 11/24; H04N 23/56; H04N 5/77; G06T 7/70

(52) U.S. Cl. CPC G06T 7/13; G01B 11/24; H04N 23/56; H04N 5/77; G06T 7/70; H04N 23/51

(57) ABSTRACT

The invention relates to a system (1) for counting corrugations in a flexible material (100). The system is provided with a carrier (10) with a measuring area (12) and with aligning means (14) for aligning the flexible material in the measuring area, a light source for illuminating the measuring area, a camera for making one or more image recordings of the measuring area and a processor (23), which is arranged for counting the number of corrugations in one or more of the image recordings. The invention also relates to a method for counting a desired number of corrugations in a flexible material, for example pleats in fabric for a window covering, such as a pleated curtain. The invention furthermore relates to a computer program comprising instructions for carrying out the steps of the method.

The invention relates to a system and method for counting corrugations in a flexible material, for example pleats in a fabric for window coverings, such as a pleated curtain.

### BACKGROUND

It is an object of the invention to make the production process of customizing an individual fabric package for window coverings proceed faster and more reliably. For pleated curtains this production process comprises the production step of counting the necessary number of pleats or folds per fabric package. In practice, this is done manually. It is very time-consuming to do this accurately.

The system mentioned in the preamble is provided with a carrier with a surface for positioning the flexible material, a light source for illuminating the flexible material on the carrier, receiving means for receiving light originating from the flexible material, counting means for determining the number of corrugations in the flexible material based on data from the receiving means. Such a system is known from U.S. Pat. No. 3,935,997. The known system comprises an endless feed belt for supply of pleated material for lamp shades from a roll past an assembly that counts the pleats in the passing material. The counting takes place by means of a photocell that captures light reflections from the pleats and a detector that converts the light reflections into pulses, which are counted. An operator keeps on marking the passing material manually when reaching the desired number of pulses, which is a measure of the number of pleats.

The known system is not suitable for customizing individual fabric packages for window coverings.

### SUMMARY OF THE INVENTION

The system according to the present invention is thereto characterized in that the carrier is provided with a measuring area and with aligning means for aligning the flexible material in the measuring area, in that the receiving means comprise a camera for making one or more image recordings of the measuring area and in that the counting means comprise a processor, which is arranged for counting the number of corrugations in one or more of the image recordings, wherein the system is further provided with means for displaying the number of counted corrugations in the flexible material in the measuring area. The method according to the present invention thereto comprises the following steps:
a) Positioning and spreading of at least a part of the flexible material in a measuring area on a carrier;
b) Illuminating the measuring area;
c) Making an image recording of the measuring area;
d) Analyzing the image recording; and
e) Counting the number of corrugations in the image recording;
f) Displaying the counted number of corrugations;
g) Repeating the steps a) up until f) until the desired number of corrugations corresponds to the counted number of corrugations.

The system and the method according to the invention offer an operator the opportunity to customize fabric packages for window coverings separately by counting the number of pleats dynamically.

Examples of suitable display means are a screen or a counter. The operator then receives direct feedback from the system of the situation at that moment.

In a first preferred embodiment of the system according to the invention, the processor is arranged for analyzing the contrast between the flexible material and the measuring area in an image recording. The first preferred embodiment makes it possible to measure corrugations in various kinds of flexible materials, among which multi-layer fabrics, such as honeycomb pleats. According to a further preferred embodiment of the system according to the invention, the measuring area comprises light-permeable material and the light source forms a backlight source for the camera. This increases the contrast between the flexible material and the measuring area in the image recording further.

In an elegant elaboration hereof with optimal contrast, the light source and the camera are arranged on opposite sides of the measuring area. In a practical preferred embodiment of the system according to the invention, the camera is accommodated in a housing, which housing is arranged on the surface of the carrier. The camera is now always in an aligned position with respect to the measuring area on the carrier.

In a subsequent preferred embodiment of the system according to the invention, the aligning means comprise a stop, which defines a corner in the measuring area. When the flexible material lies against such a stop, a part of the measuring area automatically remains free, such that a contrast with the flexible material is always visible in the image recordings.

In another preferred embodiment, the system according to the invention is further provided with marking tools for marking a line on the surface. Preferably, the marking tools are arranged for projecting the line. The line serves as borderline for the measuring area and/or as cutting line. The operator can directly cut the flexible material with the desired number of corrugations to size along the cutting line.

In a very precise preferred embodiment of the system according to the invention with above-mentioned stop, the marking tools for projecting the line are arranged for projecting the line along one of the legs of the corner of the stop.

In an optimal preferred embodiment of the system according to the invention, the processor is arranged for carrying out the following steps:
Increasing the contrast between the flexible material and the measuring area in an image recording of the camera;
Determining a contour line in the image recording, which follows the corrugations along an edge of the flexible material in the image recording;
Determining the coordinates of the peaks of the contour line;
Counting the number of peaks in the image recording as a measure of the number of corrugations; and
Displaying the counted number of peaks as a measure of the number of corrugations.

Due to these steps, the system can measure the number of corrugations very accurately, even with very translucent material, stains, patterns and/or color gradient in the flexible material. In a further elaboration of the system, the last step preferably takes place by the processor being arranged for carrying out the step of displaying an image recording, wherein the counted corrugations are marked. The operator can now check at a glance whether all present corrugations have actually been counted.

The invention also relates to a computer program comprising instructions to let the system according to the invention carry out at least the steps b) up until f) of the method according to the invention.

### DESCRIPTION OF THE DRAWING

The invention will now be explained in more detail with reference to the figures, wherein:

FIG. 1 shows a schematic view of a preferred embodiment of the system according to the invention;

FIG. 2 shows a side view of the system from FIG. 1 in cross-section;

FIG. 3 shows a schematic display of a part of the system from FIG. 1;

FIG. 4 shows an image recording of the flexible material, which is made using the system according to the invention;

FIG. 5 shows the image recording from FIG. 4 after editing; and

FIG. 6 shows the image recording from FIG. 5 with contour; and

FIG. 7 shows a display on a screen as part of the system from FIG. 1.

Identical reference numbers in the different figures refer to the same parts.

### DETAILED DESCRIPTION

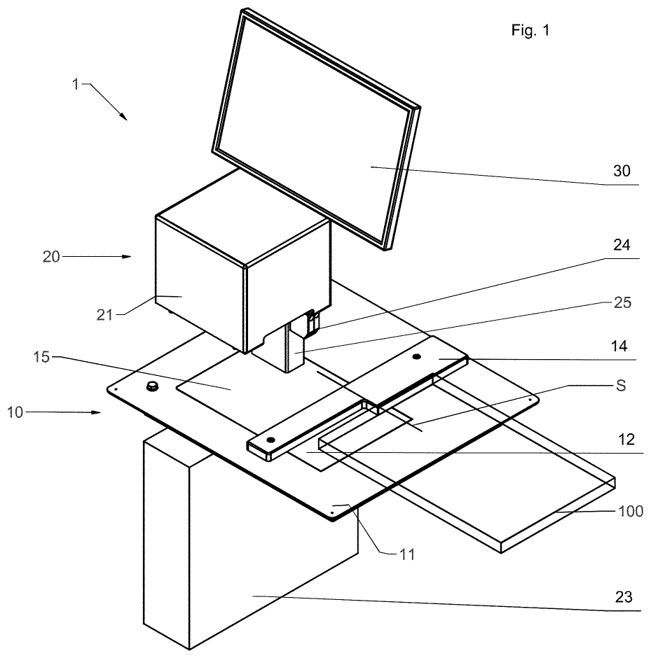

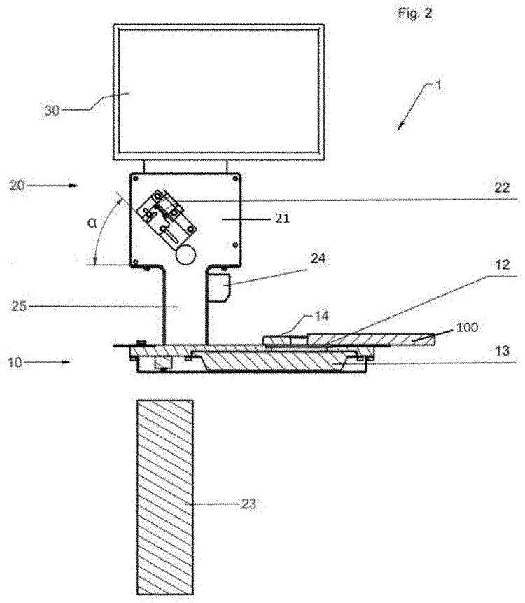

FIG. 1 shows a schematic view of a system 1 according to the invention in a preferred embodiment. FIG. 2 shows a side view of the system 1 in cross-section.

The system 1 is arranged for counting corrugations in a flexible material, for example pleats in a fabric of a window covering 100. The system 1 is thereto provided with a carrier 10 for positioning the flexible material 100. In the shown preferred embodiment, the carrier 10 comprises a substantially flat surface 11, on which a measuring area 12 is defined.

The system 1 is provided with a light source 13 for illuminating the measuring area 12 on the carrier 10.

The system 1 is further provided with a system 20 for receiving and analyzing light originating from the flexible material 100 for counting the number of pleats in (a part of) the flexible material.

In the shown preferred embodiment, the flexible material is a fabric with pleats for a window covering, such as a pleated curtain or pleated blind. This includes all pleated fabrics known in the art with different pleat widths, among which the standard dimensions of 20, 25, 32 or 45 mm.

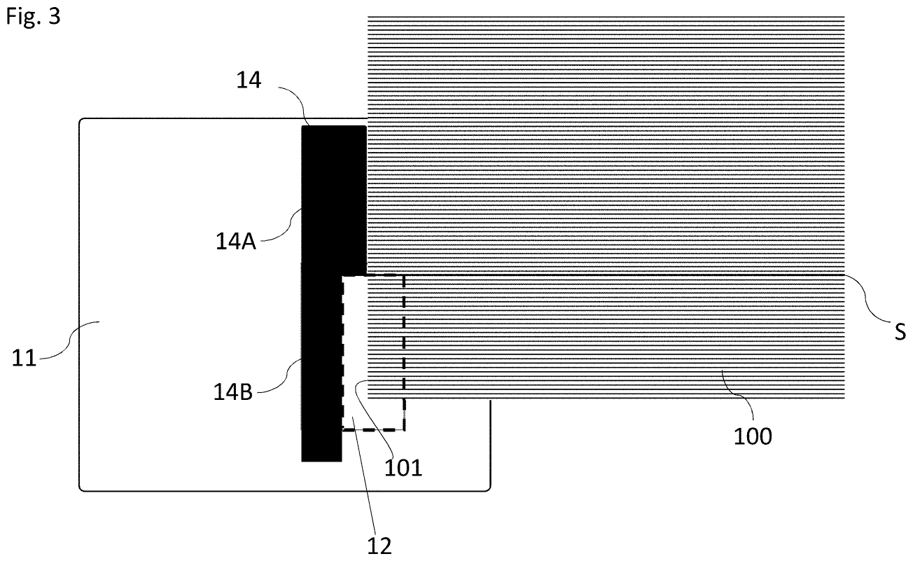

FIG. 3 shows a schematic display of a part of the carrier 10 with a pleated curtain fabric 100. The system 1 further comprises aligning means for aligning the fabric 100 in the measuring area 12 on the carrier 10. In the shown preferred embodiment, the aligning means comprise a stop 14 for aligning an edge 101 of the fabric. The aligning means also define the measuring area 12.

Preferably the stop 14 is fixed on the carrier 10. In the shown preferred embodiment, the stop 14 adjoins the measuring area 12. In the shown preferred embodiment, the stop 14 delimits a corner of the measuring area 12. The stop 14 has a wider part 14A for aligning the pleated curtain fabric 100 and a smaller part 14B which borders on the measuring area 12. In use of the system 1, the measuring area 12 is partly covered by the flexible material 100 due to the stop 14.

A screen 30 is provided for displaying the number of pleats that is present in the measuring area 12 at a certain moment.

The screen preferably has a touchscreen. The screen can be part of the operating means.

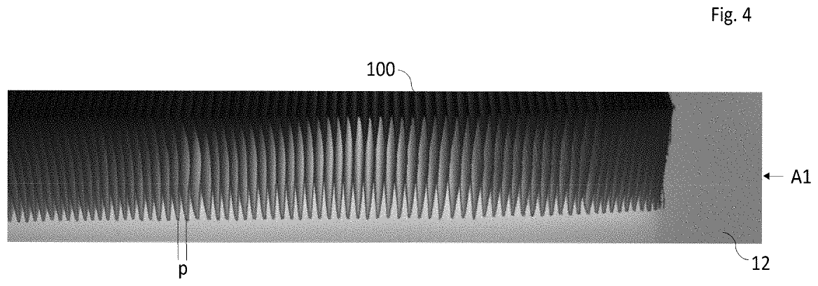

The system 20 comprises light-receiving means for receiving the light originating from the flexible material. In the shown preferred embodiment, the light-receiving means comprise a camera 22 for making image recordings of the measuring area 12 with the fabric. An example of such an image recording or image A1 is shown in FIG. 4.

The system 20 comprises a processor 23 for counting the number of pleats by analyzing the image recordings.

According to the invention, the processor is arranged for analyzing the contrast in the image recordings between an edge 101 of the fabric 100 and the measuring area 12.

According to the invention, the light source 13 forms a backlight source for the camera 22. In the shown preferred embodiment, the measuring area 12 is light-permeable and the light source 13 and the camera 22 are positioned on opposite sides of the measuring area 12 of the carrier 10.

A suitable light source is a LED-light. A suitable, light-permeable material for the measuring area 12 is hardened glass, for example borosilicate glass.

FIG. 4 illustrates an image recording A1 of the measuring area 12 with the fabric 100 made using the camera 22. The pleats P that need to be counted are clearly visible. The processor 23 is arranged for counting the number of pleats P and carries out the following steps.

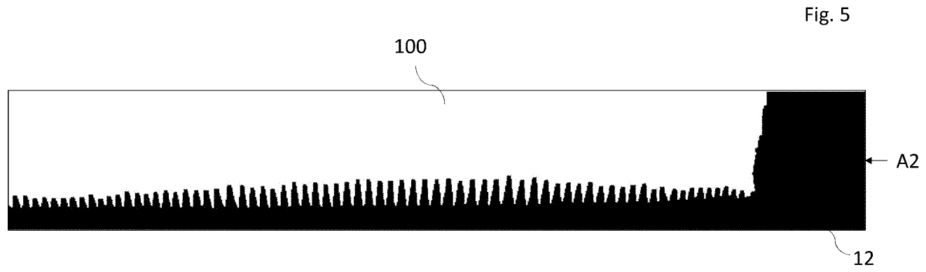

In a first step, the contrast between the fabric and the background, which is formed in system 1 by the measuring area 12, is made clearer. Suitable image processing techniques, especially contrast-increasing image processing techniques, are hereto known in the relevant art and available for a person skilled in the art. Preferably a so-called binary image recording A2 is made, wherein the fabric is displayed in a certain color and the background in a different color, for example black. FIG. 5 shows an example of such an image recording A2.

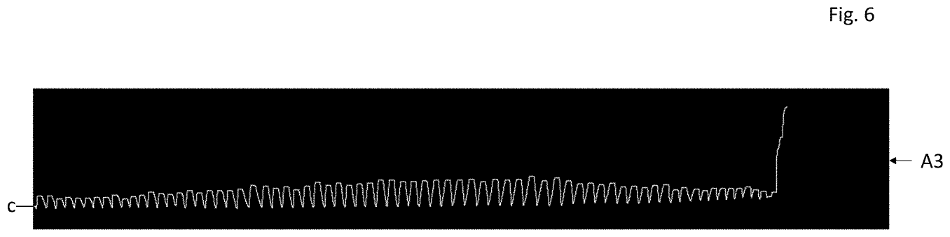

In a second step, a contour line C is determined, which follows the edge of the fabric with pleats. In order to illustrate, FIG. 6 shows an image recording A3, wherein the contour C is displayed. The contour C is determined as an x y chart, whereby for each x-coordinate the associated y-coordinate is determined by searching for the transition between the background (the measuring area 12) and the fabric 100.

Subsequently, in the contour C the coordinates of the peaks of the contour C, which correspond with the pleats, are determined. Suitable algorithms for this are known in the relevant art and available for a person skilled in the art.

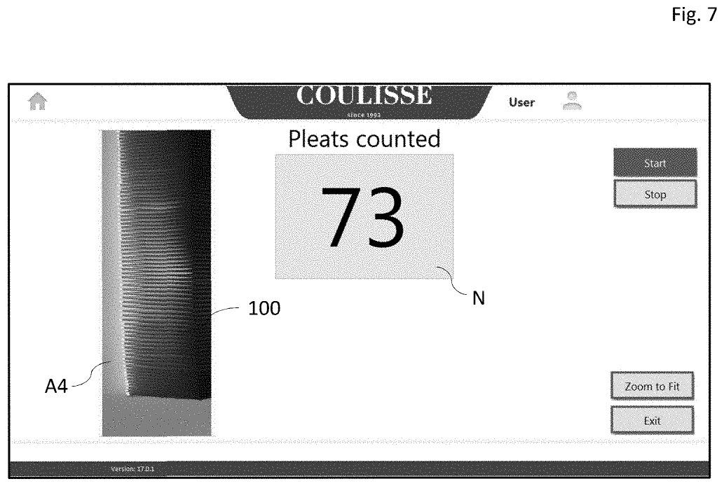

The processor 23 counts the number of peaks N and visualizes this number. In the system 1, the number N is displayed on the screen 30. Optionally, the peaks are marked in an image recording A4. This provides a user the option for a visual check to determine that all present pleats have been found and counted. FIG. 7 shows a screenshot of the screen 30 of the system 1 with an example of an image recording A4.

The system 1 displays the number of pleats dynamically. The user can slide the fabric over the carrier 10 in order to vary the number of pleats in the measuring area 12 until the desired number of pleats has been reached. The camera 22 preferably makes sufficient image recordings per unit of time to give the user the impression that the counting and the display of the number of pleats N takes places in real-time. In the preferred embodiment, a camera that depicts 17 frames per seconds is suitable.

The system optionally comprises marking tools for marking the line S on the surface 11. The line S preferably runs over the transition between part 14A and 14B of the stop 14. The line S defines the measuring area 12. The line S forms an upper limit on the fabric 100 for the measured pleats of the fabric 100 and at the same time serves as cutting line. When the desired number of pleats has been reached, the fabric can be cut along the line S, for example by the operator. In the shown preferred embodiment, the marking tools comprise projection means 24, for example a laser, for temporary and contactless indication of the line S.

The system 1 is provided with suitable operating means. In the shown preferred embodiment, the screen 30 is a touchscreen with, for example, operating buttons, such as ‘start’ and ‘stop’. By means of these operating buttons or alternative, mechanical operating means, such as a push button or a foot pedal, the operator can manually control the measurement. Optionally, the system can start automatically upon presenting the fabric in the measuring area.

In the shown preferred embodiment, the system 20 comprises a housing 21, wherein the camera 22 is accommodated. The marking tools 24 are fixed to the housing 21. The housing 21 is provided with a stand 25, which is fixed on the surface 11 of the carrier 10. Optionally, a mounting plate 15 is hereto provided.

The camera 22 is, with respect to the measuring area 12, set up obliquely on the carrier 10. The camera 22 makes optimal image recordings of the measuring area at a camera angle α, wherein 40<α<50 degrees, preferably α=45, wherein all corrugations are clearly visible.

In the shown preferred embodiment, the system 1 can be fixed on a larger work top by means of the carrier 10. The carrier 10 can for example be integrated in a suitable work top. The processor 23 can for example be placed under the work top. The screen 30 can for example stand on the housing 21.

The present invention is based on the inventive idea of making a dynamic counting of the number of corrugations in a flexible material possible for all kinds of materials by carrying out a contrast measurement. The invention hereto provides a contrast analyzing system and a method for the usage of the system. The above-mentioned contrast-increasing measures, both separately as in combination, contribute to the pleats being detectable even with a small light gap between them. One can think of a light gap of <0.5 mm or even <0.3 mm. This is advantageous in the case of a fabric package for a window covering that is usually pressed together very tightly in the packaging. The operator only needs to spread the fabric very lightly to be able to perform the counting.

The invention is naturally not limited to the described and shown preferred embodiment. Optionally, system 1 comprises for example multiple cameras 22 that each make image recordings of the measuring area. In the housing 21 two cameras can for example be accommodated adjacent to each other. The image recordings of the different cameras can be merged into an image. Suitable techniques for this, such as ‘image stitching’, are known in the relevant art. Usage of multiple cameras leads to a larger measuring area and makes the system according to the invention suitable for counting corrugations in flexible material with larger dimensions. The invention therefore extends to any embodiment falling within the scope of protection, such as defined in the claims and seen in the light of the preceding description and accompanying figures.

1. A system for counting corrugations in a flexible material, which system is provided with a carrier with a surface for positioning the flexible material, a light source for illuminating the flexible material on the carrier, receiving means for receiving light originating from the flexible material, counting means for determining the number of corrugations in the flexible material based on data from the receiving means, wherein the carrier is provided with a measuring area and with aligning means for aligning the flexible material in the measuring area, wherein the receiving means comprise a camera for making one or more image recordings of the measuring area and wherein the counting means comprise a processor, which is arranged for counting the number of corrugations in one or more of the image recordings, wherein the system is further provided with means for displaying the number of counted corrugations in the flexible material in the measuring area.

2. The system according to claim 1, wherein the processor is arranged for analyzing the contrast between the flexible material and the measuring area in an image recording.

3. The system according to claim 1, wherein the measuring area comprises light-permeable material and the light source forms a backlight source for the camera.

4. The system according to claim 3, wherein the light source and the camera are arranged on opposite sides of the measuring area.

5. The system according to claim 1, wherein the camera is accommodated in a housing, which housing is arranged on the surface of the carrier.

6. The system according to claim 1, wherein the camera is, with respect to the measuring area, set up obliquely on the carrier.

7. The system according to claim 6, wherein the camera is set up at a camera angle α, wherein 40<α<50 degrees, preferably α=45.

8. The system according to claim 1, wherein the aligning means comprise a stop, which defines a corner in the measuring area.

9. The system according to claim 1, wherein the system is further provided with marking tools for marking a line on the surface, preferably by means of projection.

10. The system according to claim 1, wherein the system is arranged for displaying the number of counted corrugations in the measuring area in real-time.

11. The system according to claim 2, wherein the processor is arranged for carrying out the following steps:
Increasing the contrast between the flexible material and the measuring area (12) in an image recording of the camera;
Determining a contour line in the image recording, which follows the corrugations along an edge of the flexible material in the image recording;
Determining the coordinates of the peaks of the contour line;
Counting the number of peaks in the image recording as a measure of the number of corrugations; and
Displaying the counted number of peaks as a measure of the number of corrugations.

12. The system according to claim 11, wherein the processor is arranged for carrying out the step of displaying an image recording, wherein the counted corrugations are marked.

13. The system according to claim 1, wherein the system is arranged for counting corrugations in a fabric for window coverings.

14. A method for counting a desired number of corrugations in a flexible material, wherein the method comprises the following steps:
a) Positioning and spreading of at least a part of the flexible material in a measuring area on a carrier;
b) Illuminating the measuring area;
c) Making an image recording of the measuring area;
d) Analyzing the image recording;
e) Counting the number of corrugations in the image recording;
f) Displaying the counted number of corrugations;
g) Repeating the steps a) up until f) until the desired number of corrugations corresponds to the counted number of corrugations.

15. The method according to claim 14, wherein use is made of a system for counting corrugations in a flexible material, which system is provided with a carrier with a surface for positioning the flexible material, a light source for illuminating the flexible material on the carrier, receiving means for receiving light originating from the flexible material, counting means for determining the number of corrugations in the flexible material based on data from the receiving means, wherein the carrier is provided with a measuring area and with aligning means for aligning the flexible material in the measuring area, wherein the receiving means comprise a camera for making one or more image recordings of the measuring area and wherein the counting means comprise a processor, which is arranged for counting the number of corrugations in one or more of the image recordings, wherein the system is further provided with means for displaying the number of counted corrugations in the flexible material in the measuring area.

16. A computer program comprising instructions to let the system according to claim 1 carry out at least the steps b) up until f) of the method according to claim 14.
